(19) United States
(12) Patent Application Publication
(10) Pub. No.: US 2024/0066949 A1
(43) Pub. Date: Feb. 29, 2024

(54) DETECTING AND RESPONDING TO A MOISTURE CONDITION OF AN AUTONOMOUS VEHICLE

(71) Applicant: GM Cruise Holdings LLC, San Francisco, CA (US)

(72) Inventors: Domenico Rusciano, Concord, CA (US); Jeffrey Robert Brandon, Phoenix, AZ (US)

(21) Appl. No.: 17/898,152

(22) Filed: Aug. 29, 2022

(51) Int. Cl. B60H 1/00; B60H 1/32; G05D 1/02

(52) U.S. Cl. CPC B60H 1/00785; B60H 1/00021; B60H 1/00771; B60H 1/3207; G05D 1/0214; G05D 1/0291; B60H 2001/00114; B60H 2001/3244; G05D 2201/0213

(57) ABSTRACT

Systems, methods, and computer-readable media are provided for detecting and responding to a moisture condition of an autonomous vehicle (AV). In some examples, an AV fleet management device may detect a moisture condition within AV based on sensor data received from the AV. In some aspects, in response to detecting the moisture condition, the AV fleet management device may determine, based on the sensor data, that a humidity level within the autonomous vehicle exceeds a threshold humidity level or a wet surface within the autonomous vehicle is present. In some cases, a drying procedure may be determined or selected for reducing the humidity level or drying the wet surface within the autonomous vehicle.

### BACKGROUND

### 1. Technical Field

The present disclosure generally relates to autonomous vehicles and, more specifically, to detecting and responding to a moisture condition of autonomous vehicles.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) navigation and routing operations, according to some aspects of the present disclosure;

FIG. 2 illustrates an example of a deep learning neural network that can be used to implement a detection and response of a moisture condition of an autonomous vehicle, according to some aspects of the present disclosure;

FIG. 3 illustrates an example system for detecting and responding to a moisture condition of an autonomous vehicle, according to some aspects of the present disclosure;

FIG. 4 illustrates an example of a process for detecting and responding to a moisture condition of an autonomous vehicle, according to some aspects of the present disclosure;

FIG. 5 illustrates another example of a process for detecting and responding to a moisture condition of an autonomous vehicle, according to some aspects of the present disclosure; and

FIG. 6 illustrates an example processor-based system with which some aspects of the subject technology can be implemented, according to some aspects of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles, also known as self-driving cars, driverless vehicles, and robotic vehicles, are vehicles that use sensors to sense the environment and move without human input. Automation technology in the autonomous vehicles enables the vehicles to drive on roadways and to perceive the vehicle's environment accurately and quickly, including obstacles, signs, and traffic lights. In some cases, the autonomous vehicles can be used to pick up passengers and drive the passengers to selected destinations. In some examples, the autonomous vehicles may be used to transport pets and/or to deliver goods such as groceries and other household items.

During adverse weather conditions such as rain or snow, a vehicle for hire such as a ridehail vehicle can accumulate moisture inside the vehicle as passengers embark and disembark with wet personal belongings and attire including, but not limited to, umbrellas, shoes, handbags, boots, and raincoats. Furthermore, a passenger may cause a liquid spill in the vehicle such as on the seats or floor. The moisture inside the vehicle can be treated when a human operator determines that the vehicle needs servicing (e.g., vehicle cleaning). In the case of an autonomous vehicle, there is no way to detect moisture inside the vehicle that may require attention prior to a next scheduled servicing. Timely detection and response of moisture inside the autonomous vehicle is important to prevent an uncomfortable experience for a passenger due to wet seats and vehicle surfaces that can accumulate from current and past riders. Moreover, detecting and responding to moisture inside the vehicle is important to minimize the probability of a potential safety hazard.

Solutions are provided herein for detecting and responding to a moisture condition of an autonomous vehicle (e.g., humidity level exceeds a pre-determined humidity level or threshold and/or one or more wet surfaces are present in the autonomous vehicle). In some aspects, an autonomous vehicle fleet management device may detect a moisture condition based on sensor data received from sensors located within the autonomous vehicle. In some instances, the sensor data may include, but is not limited to, humidity sensor data that measures a humidity level of an interior of the autonomous vehicle, and/or camera data (e.g., image data or video data), that is received from one or more cameras, and that represents the interior of the autonomous vehicle. In some examples, an autonomous vehicle fleet management device may send instructions to the autonomous vehicle to implement a drying procedure (e.g., open the windows, turn on the HVAC system, and/or activate the ventilated seat system of the autonomous vehicle) if a moisture condition is detected (e.g., the humidity level of the autonomous vehicle exceeds a pre-determined humidity level and/or one or more wet surfaces are captured by a camera). In some cases, the autonomous vehicle fleet management device may set a pre-determined humidity level based on a plurality of humidity measurements from a plurality of autonomous vehicles.

In some examples, an autonomous vehicle may detect and respond to a moisture condition without instructions from an autonomous vehicle fleet management device. This is an alternative to the autonomous vehicle fleet management device detecting and responding to the moisture condition, determining a drying procedure and sending instructions to the autonomous vehicle to implement the drying procedure.

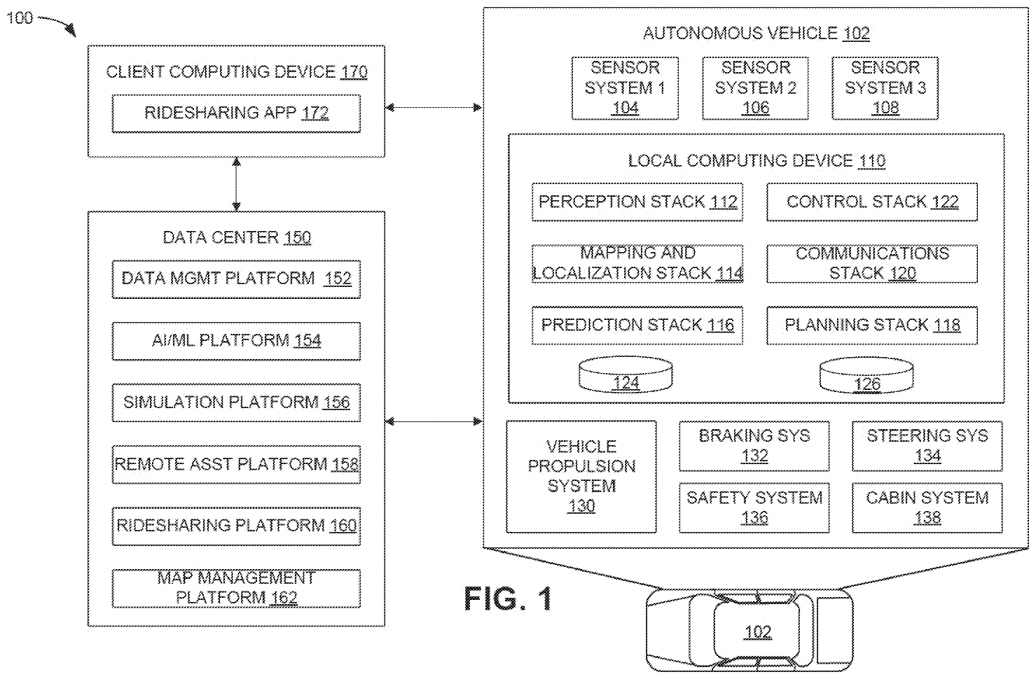

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill in the art will appreciate that such variations do not depart from the scope of the present disclosure.

In this example, the AV management system 100 includes an AV 102, a data center (also autonomous vehicle fleet management device, autonomous vehicle fleet management system, management system) 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack 116 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the mapping and localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, mapping and localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

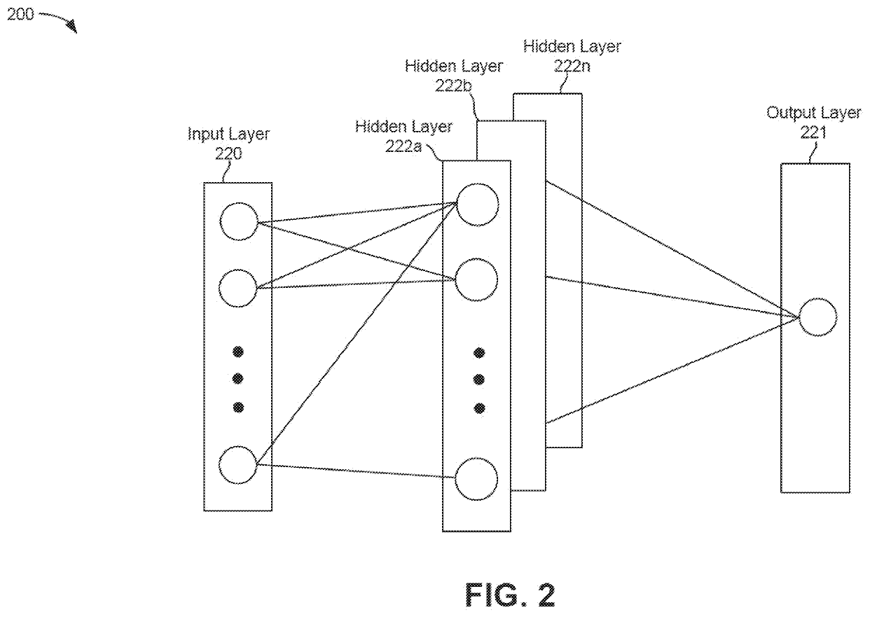

In FIG. 2, the disclosure now turns to a further discussion of models that can be used through the environments and techniques described herein. FIG. 2 illustrates an example of a deep learning neural network 200 that can be used to implement all or a portion of the solutions described herein. For example, neural network 200 can be used to implement a perception module (or perception system) as discussed above. In another example, neural network 200 can be used to process sensor data (e.g., image data or video data that is received from one or more cameras; humidity level data from one or more humidity sensors) to detect a moisture condition of an autonomous vehicle. In some examples, neural network 200 may be implemented at AV 102, data center 150, and/or client computing device 170.

In some examples, an input layer 220 can be configured to receive sensor data and/or data relating to an environment surrounding an AV. The neural network 200 includes multiple hidden layers 222a, 222b, through 222n. The hidden layers 222a, 222b, through 222n include “n” number of hidden layers, where “n” is an integer greater than or equal to one. The number of hidden layers can be made to include as many layers as needed for the given application. The neural network 200 further includes an output layer 221 that provides an output resulting from the processing performed by the hidden layers 222a, 222b, through 222n. In one illustrative example, the output layer 221 can provide estimated treatment parameters, that can be used/ingested by a differential simulator to estimate a patient treatment outcome.

The neural network 200 is a multi-layer neural network of interconnected nodes. Each node can represent a piece of information. Information associated with the nodes is shared among the different layers and each layer retains information as information is processed. In some cases, the neural network 200 can include a feed-forward network, in which case there are no feedback connections where outputs of the network are fed back into itself. In some cases, the neural network 200 can include a recurrent neural network, which can have loops that allow information to be carried across nodes while reading in input.

Information can be exchanged between nodes through node-to-node interconnections between the various layers. Nodes of the input layer 220 can activate a set of nodes in the first hidden layer 222a. For example, as shown, each of the input nodes of the input layer 220 is connected to each of the nodes of the first hidden layer 222a. The nodes of the first hidden layer 222a can transform the information of each input node by applying activation functions to the input node information. The information derived from the transformation can then be passed to and can activate the nodes of the next hidden layer 222b, which can perform their own designated functions. Example functions include convolutional, up-sampling, data transformation, and/or any other suitable functions. The output of the hidden layer 222b can then activate nodes of the next hidden layer, and so on. The output of the last hidden layer 222n can activate one or more nodes of the output layer 221, at which an output is provided. In some cases, while nodes in the neural network 200 are shown as having multiple output lines, a node can have a single output and all lines shown as being output from a node represent the same output value.

In some cases, each node or interconnection between nodes can have a weight that is a set of parameters derived from the training of the neural network 200. Once the neural network 200 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 200 to be adaptive to inputs and able to learn as more and more data is processed.

The neural network 200 is pre-trained to process the features from the data in the input layer 220 using the different hidden layers 222a, 222b, through 222n in order to provide the output through the output layer 221.

In some cases, the neural network 200 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 200 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 200 can perform a backward pass by determining which inputs (weights) most contributed to the loss of the network and can adjust the weights so that the loss decreases and is eventually minimized.

The neural network 200 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 200 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

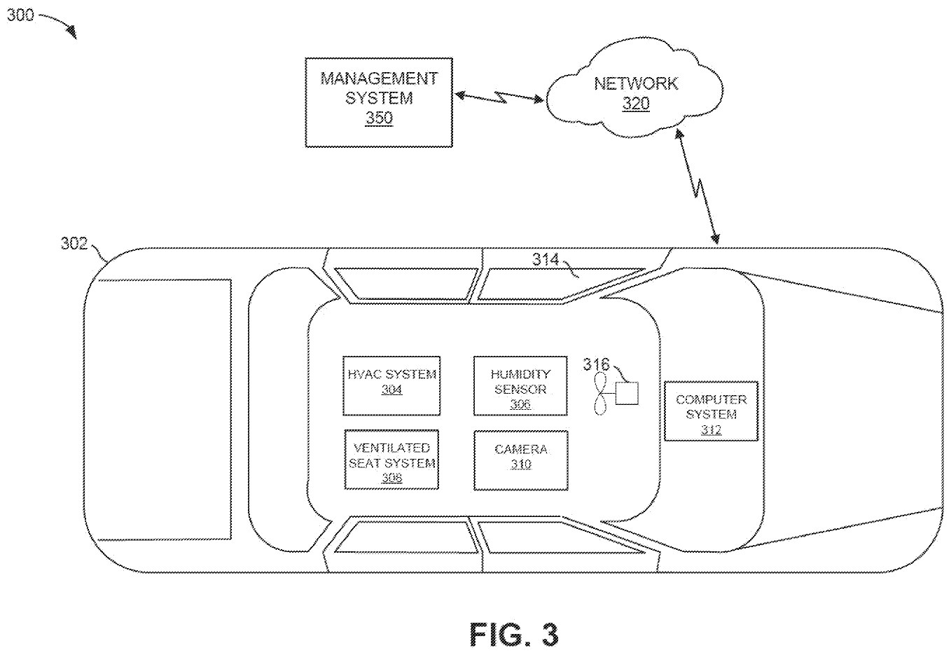

FIG. 3 illustrates an example of a system 300 that may be configured to detect and respond to a moisture condition of an autonomous vehicle (AV). In some aspects, system 300 may include AV 302 (e.g., AV 102 illustrated in FIG. 1). In some cases, AV 302 may include a heating, ventilation, and air conditioning (HVAC) system 304. The HVAC system 304 provides heating and cooling within the AV 302. The HVAC system 304 can use a heater to warm the air and an evaporator to cool the air through the evaporation of refrigerant gas. In some cases, HVAC system 304 may include a dehumidifier. In some instances, hot and cold air controlled by the HVAC system 304 is blown into the AV 302 via one or more air vents 316. In some examples, one or more air vents 316 within AV 302 can heat and cool areas including but not limited to the floor (e.g., front and rear passenger floors), ceiling, seats (e.g., front and rear passenger seats), and other AV 302 surfaces. AV 302 may include a ventilated seat system 308. For example, ventilated seat system 308 can provide air circulation through a porous fabric towards the outer surface of the seats (e.g., front and rear passenger seats). In some cases, the air may be refrigerated, heated or at ambient temperature.

Humidity sensors 306, which can be placed at various locations within AV 302, can be used to measure a humidity level within AV 302. The humidity sensors 306 can be configured to transmit and receive data to and from computer system 312. For example, one or more of humidity sensors 306 can transmit humidity level measurements to computer system 312. Additionally, computer system 312 can send instructions to one or more humidity sensors 306, e.g., to trigger a humidity measurement within, and/or to cause humidity sensor 306 to transmit humidity measurements to computer system 312.

In some examples, one or more cameras (e.g., still image cameras, video cameras) 310 can capture image data and/or video data within AV 302. In some aspects, one or more cameras 310 can capture image data and/or video data of the entire interior of AV 302 (e.g., one or more cameras 310 can be placed throughout AV 302 to capture the entire interior). The cameras 310 can be attached to an actuator or equivalent mechanical device (e.g., an electronic actuator that can communicate with computer system 312) that can point cameras 310 to different areas within AV 302. In some cases, cameras 310 can transmit and receive data to and from computer system 312. For example, one or more cameras 310 can transmit collected image data and/or video data to computer system 312. In some cases, computer system 312 can send instructions to one or more cameras 310 (e.g., capture image data and/or video data within AV 302, zoom in or zoom out to an area of AV 302, transmit image data and/or video data to computer system 312, point to an area of AV 302, turn on or off, etc.). Those skilled in the art will recognize that additional sensor types other than a camera 310 and/or humidity sensor 306 may be used to detect a moisture condition in AV 302.

In some cases, computer system 312 (e.g., local computing device 110 illustrated in FIG. 1) can communicate (e.g., send and receive data) with HVAC system 304, ventilated seat system 308, humidity sensor 306, camera 310, management system 350 (e.g., data center 150 illustrated in FIG. 1) in addition to other systems in AV 302. In some aspects, computer system 312 can communicate with one or more windows 314 within AV 302. For example, computer system 312 can open or close one or more windows 314. In another example, computer system 312 can activate the different settings of HVAC system 304 and ventilated seat system 308. In some instances, computer system 312 may communicate (e.g., send and receive data) with management system 350 via wireless network 320. In some examples, management system 350 can communicate with HVAC system 304, ventilated seat system 308, humidity sensor 306, camera 310, windows 314 via wireless network 320 and computer system 312. For example, if management system 350 sends instructions to HVAC system 304, it first sends the instructions to network 320, then from network 320 to computer system 312, and finally from computer system 312 to HVAC system 304.

Computer system 312 and/or management system 350 can be configured to detect and respond to moisture conditions of AV 302. By way of example, computer system 312 can use various machine learning algorithms to detect and determine how to respond to or manage various detected moisture conditions of AV 302. In some approaches, computer system 312 and/or management system 350 can continuously or intermittently (e.g., at certain time intervals such as every 10 mins, every hour, etc.) monitor for a moisture condition. In some cases, computer system 312 and/or management system 350 can receive one or more humidity levels (e.g., measurement of humidity level) from one or more humidity sensors 306. In some instances, computer system 312 and/or management system 350 can use a subset of one or more humidity sensors 306 (e.g., use a humidity measurement from some of the humidity sensors 306 and not the others) or combine the measured humidity levels from one or more humidity sensors 306 (e.g., take an average of the measured humidity levels).

Computer system 312 and/or management system 350 can send be configured to send instructions to HVAC system 304, ventilated seat system 308 and/or one or more windows 314 to reduce the humidity level within AV 302 if the humidity level exceeds a pre-determined humidity level or threshold. For example, computer system 312 can send instructions to HVAC system 304 to circulate air (e.g., hot or cold air at various temperatures and intensities) via one or more air vents 316 to reduce the humidity level within AV 302. In some cases, computer system 312 and/or management system 350 can instruct one or more windows 314 to open to reduce the humidity level. In some instances, computer system 312 and/or management system 350 can send instructions to the ventilated seat system 308 to circulate air through one or more seats to reduce the humidity level. In some cases, the pre-determined humidity level or threshold may be received by management system 350 or from computer system 312. In some examples, management system 350 can set the pre-determined humidity level or threshold based on typical humidity levels for a given geographic area, or across a subset of AV fleet vehicles. For example, humidity measurements from various AVs (e.g., AVs in communication with management system 350 and/or one or more AVs in the same geographic location as AV 302).

In some aspects, computer system 312 and/or management system 350 can receive image data and/or video data from one or more cameras 310 and use various machine learning algorithms to detect wet surfaces at any location within AV 302. In some examples, computer system 312 and/or management system 350 can send instructions as discussed above to HVAC system 304, ventilated seat system 308 and/or one or more windows 314 to dry one or more wet surfaces within AV 302.

In some aspects, computer system 312 and/or management system 350 can continuously or intermittently (e.g., at certain time intervals such as every 10 mins, every hour, etc.) monitor the humidity level within AV 302 and reduce the humidity level as discussed above if the humidity level exceeds a pre-determined humidity level or threshold. In some cases, computer system 312 and/or management system 350 can use various machine learning algorithms to detect one or more passengers in AV 302 and respond to a moisture condition accordingly (e.g., if a passenger is present, computer system 312 and/or management system 350 may not reduce the humidity level or dry a wet surface which may disturb the passenger; the pre-determined humidity level or threshold, i.e. the humidity level to trigger the dehumidification process, may be set to a higher value). In some aspects, computer system 312 and/or management system 350 may use various machine learning algorithms to respond to a moisture condition based on whether AV 302 is in operation as a ride-hail, ride-share or delivery vehicle. For example, if AV 302 is in operation as a delivery vehicle configured to transport food, then computer system 312 and/or management system 350 may use HVAC system 304 to dry a wet surface at a higher intensity compared to if a passenger were present.

In some cases, computer system 312 and/or management system 350 can use various machine learning algorithms to respond to a moisture condition based on the weather outside AV 302. For example, if AV 302 is in a geographic location with high temperatures, then computer system 312 and/or management system 350 may instruct one or more windows 314 to open to reduce the humidity.

In some instances, computer system 312 and/or management system 350 can use various machine learning algorithms to plan a future route for AV 302 based on a moisture condition. For example, if computer system 312 and/or management system 350 responds to a moisture condition and calculates a 20-minute dehumidification time (e.g., 20 minutes for the humidity level to fall below the threshold), it can route AV 302 to the next passenger which is at least 20 minutes away so that there is adequate time to dehumidify the interior of AV 302. In some aspects, computer system 312 and/or management system 350 can be configured to notify a passenger of a moisture condition.

For example, notifications displayed on-screen, provided as an audible message, and/or provided to a mobile device of the passenger/user may be used to indicate a humidity/wetness state of the AV 302, e.g., to provide notification that a safety hazard is present due to a water spill on the floor or an indication of the moisture condition within AV 302 is above a certain level.

In some instances, computer system 312 and/or management system 350 can be configured to determine when to remove the AV 302 from operation, e.g., for specialized servicing. By way of example, computer system 312 and/or management system 350 may determine that a humidity level is too high, or that a major spill is present, such that the AV 302 should be directed to a service center to respond to a moisture condition. As such, the computer system 312 and/or management system 350 can be used to determine an optimal servicing location for the AV 302, e.g., based on the detected conditions, as well as a prior information available to the computer system 312 and/or management system 350 about service capabilities at various servicing stations.

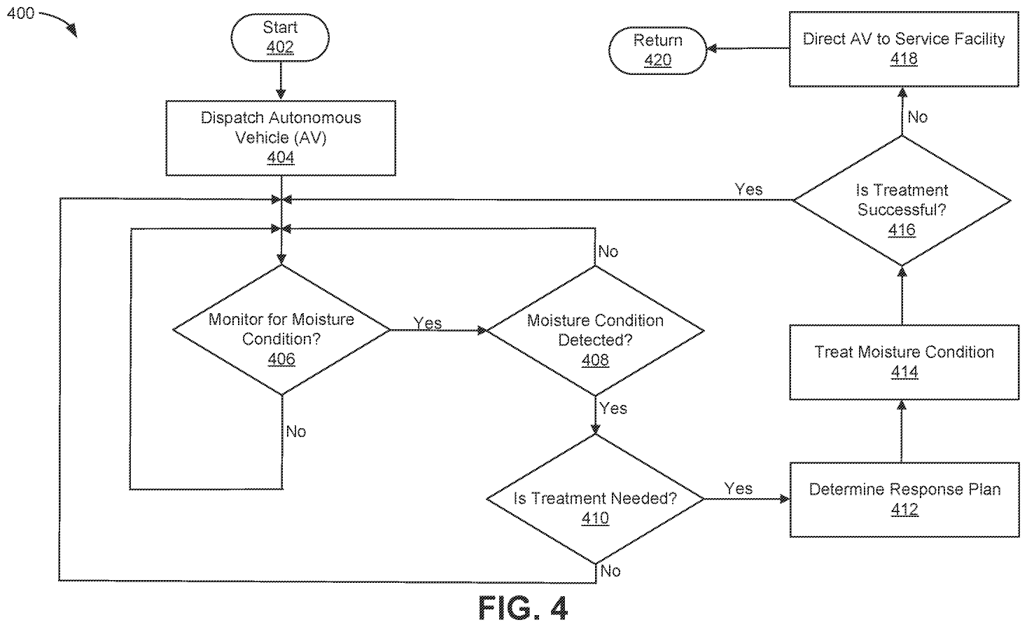

FIG. 4 illustrates an example of a process 400 for detecting and responding to a moisture condition of an autonomous vehicle. In some examples, process 400 may be performed by computer system 312 and/or management system 350. In some aspects, process 400 may start at step 402 which may include initializing hardware and software systems associated with an AV (e.g., AV 302). Process 400 may include step 404 in which the AV is dispatched (e.g., to a specific pick-up location) and/or placed in service for responding to ridesharing requests.

At step 406, the process 400 can include operations to determine whether to monitor for a moisture condition of an autonomous vehicle. For example, computer system 312 and/or management system 350 may monitor for a moisture condition continuously, during intermittent time intervals (e.g., every 10 mins, 30 mins, hour, etc.), or not at all. If computer system 312 and/or management system 350 is monitoring for a moisture condition intermittently and a requisite time hasn't transpired (e.g., if monitoring occurs every hour and it has not yet been an hour since the last check for a moisture condition), the process 400 may revert to step 406, and monitoring operations can persist. Alternatively, if computer system 312 and/or management system 350 is monitoring for a moisture condition continuously or if the requisite time has transpired, the process can proceed to step 408.

At step 408, a determination can be made as to whether a moisture condition has been detected. In some cases, a positive moisture detection can include the identification/detection of one or more wet surfaces (e.g., wet floor, wet seats) and/or a humidity level above a pre-determined humidity level or threshold within AV 302. If there is a positive moisture detection, the process may proceed to step 410. If computer system 312 and/or management system 350 determines that the humidity level within AV 302 is below a pre-determined humidity level or threshold and a wet surface is not detected, the process can loop back to step 406.

At step 410, the process 400 may determine whether treatment of the moisture condition is needed. For example, computer system 312 and/or management system 350 may determine that treatment of the moisture condition is not needed. For instance, a passenger may be present in AV 302 and treatment of a moisture condition (e.g., turning on HVAC system 304 to dry a wet surface) may not be needed as it could disturb the passenger. If a determination is made that treatment of the moisture condition is not needed, the process 400 can loop back to step 406. If a determination is made that treatment of the moisture condition is needed, the process 400 can continue to step 412.

At step 412, a response plan for the moisture condition can be determined. In some cases, computer system 312 and/or management system 350 may determine an appropriate response plan or treatment of the moisture condition (e.g., humidity level in AV 302 exceeds a pre-determined humidity level or threshold and/or one or more wet surfaces are detected). As discussed above in FIG. 3, one or more treatments may include, but are not limited to, using HVAC system 304, ventilated seat system 308, and opening one or more windows 314. As discussed above, a route of the AV may also be modified, for example, to ensure adequate drying time before a new/next passenger is permitted into the AV cabin.

At step 414, the moisture condition can be treated. For example, if the moisture condition is due to a humidity level exceeding the pre-determined humidity level or threshold, HVAC system 304 may be activated to reduce the humidity in AV 302. In another example, if the moisture condition is due to a wet surface on a seat or another surface, ventilated seat system 308 may be activated to dry the seat or other surface.

At step 416, the process 400 may determine whether the treatment of the moisture condition is successful. For example, if one or more surfaces of AV 302 are wet due to multiple liquid spills, and treatment of the moisture condition in step 414 did not successfully dry the wet surfaces, a determination may be made to continue to step 418 to direct AV 302 to a service facility. In some aspects, a service facility may include a human operator to treat the moisture condition. In some cases, a service facility may include an automated system to treat the moisture condition (e.g., an automatic car wash that may dry the interior of AV 302). At step 416, if a determination is made that the treatment is successful, the process 400 can continue to step 420 in which the process 400 returns to prior processing, which may include repeating the process 400.

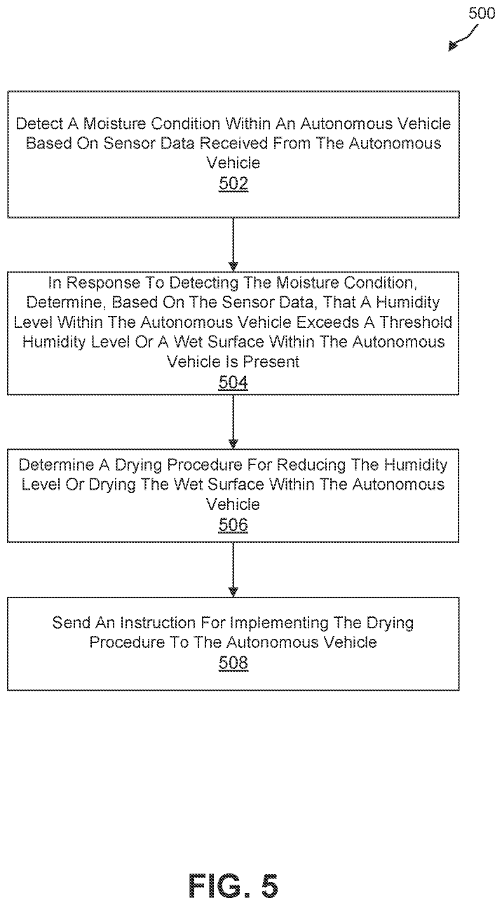

FIG. 5 illustrates another example of a process for detecting and responding to a moisture condition of an autonomous vehicle. At block 502, the process 500 includes detecting a moisture condition within an autonomous vehicle based on sensor data received from the autonomous vehicle. For example, management system 350 can receive sensor data from humidity sensor 306 and/or camera 310. In some aspects, management system 350 can receive sensor data from computer system 312 which may communicate via network 320.

At block 504, the process 500 includes determining, based on the sensor data, that a humidity level within the autonomous vehicle exceeds a threshold humidity level and/or that a wet surface within the autonomous vehicle is present. For example, management system 350 may use various machine learning algorithms to analyze the humidity sensor 306 and camera 310 data to determine if a moisture condition is present and/or if the moisture condition exceeds a predetermined (severity) threshold.

At block 506, the process 500 includes determining a drying procedure for reducing the humidity level or drying the wet surface within the autonomous vehicle. For example, management system 350 can implement one or more drying procedures for reducing the humidity level or drying the wet surface such as opening the windows, turning on the HVAC system, and activating the ventilated seat system of the autonomous vehicle.

At block 508, the process 500 includes sending an instruction for implementing the drying procedure to the autonomous vehicle. For example, management system 350 can send instructions to computer system 312 over network 320 to implement the drying procedure. In some cases, computer system 312 can communicate with HVAC system 304, ventilated seat system 308 and one or more windows 314 to implement the drying procedure.

In some cases, the process 500 can include determining the threshold humidity level based on a plurality of humidity measurements received from a plurality of autonomous vehicles, wherein the plurality of autonomous vehicles is located within a same geographic region as the autonomous vehicle. For example, management system 350 can set the threshold humidity level based on multiple autonomous vehicles located within the same geographic region as AV 302.

In some cases, the process 500 can include determining one or more weather conditions associated with a location of the autonomous vehicle. For example, management system 350 can analyze the weather outside AV 302. In some cases, the process 500 can include modifying the drying procedure based on the one or more weather conditions. In some cases, management system 350 may implement a drying procedure based on the weather outside AV 302 by opening one or more windows 314 to reduce the humidity level.

The selected drying procedure may be based on an estimated time that it will take to address/remedy the moisture condition, i.e., an estimated time that it will take to dry (or substantially dry) the AV cabin. For example, a driving instruction for the AV may be based on an estimated drying time such that a path or route taken by the AV can allow enough time for drying to be completed before further AV operations (e.g., passenger pickup) are performed.

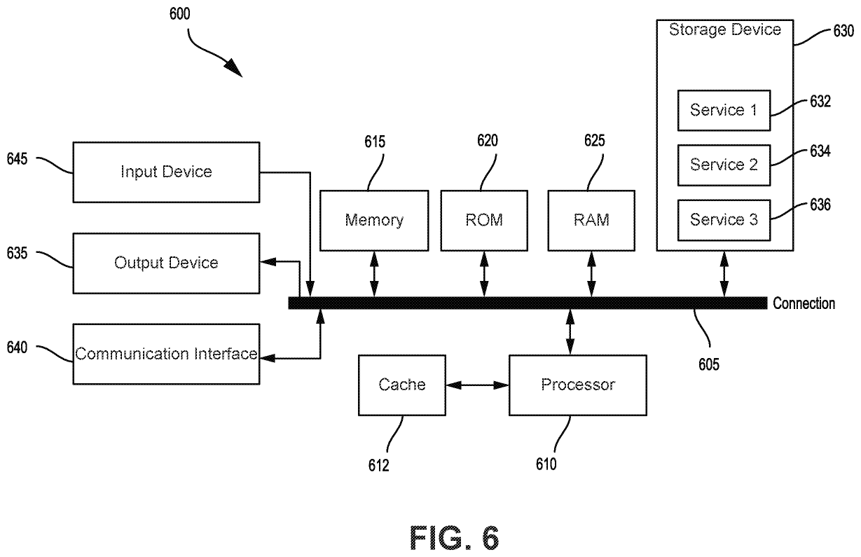

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:

Aspect 1. A method performed by an autonomous vehicle fleet management device, comprising: detecting a moisture condition within an autonomous vehicle based on sensor data received from the autonomous vehicle; in response to detecting the moisture condition, determining, based on the sensor data, that a humidity level within the autonomous vehicle exceeds a threshold humidity level or a wet surface within the autonomous vehicle is present; determining a drying procedure for reducing the humidity level or drying the wet surface within the autonomous vehicle; and sending a drying instruction for implementing the drying procedure to the autonomous vehicle.

Aspect 2. The method of Aspect 1, further comprising: determining the threshold humidity level based on a plurality of humidity measurements received from a plurality of autonomous vehicles, wherein the plurality of autonomous vehicles is located within a same geographic region as the autonomous vehicle.

Aspect 3. The method of any of Aspects 1 to 2, wherein the drying instruction for implementing the drying procedure includes at least one of a heating, ventilation, and air conditioning (HVAC) instruction, a ventilated seat instruction, and a window configuration instruction.

Aspect 4. The method of any Aspects 1 to 3, further comprising: determining one or more weather conditions associated with a location of the autonomous vehicle; and modifying the drying procedure based on the one or more weather conditions.

Aspect 5. The method of any of Aspects 1 to 4, wherein the drying procedure includes an estimated time for drying the moisture condition.

Aspect 6. The method of Aspect 5, further comprising a driving instruction that is based on the estimated time for drying the moisture condition.

Aspect 7. The method of any of Aspects 1 to 6, wherein the sensor data includes at least one of image data, video data, and humidity data.

Aspect 8. The method of any of Aspects 1 to 7, further comprising a driving instruction to route the autonomous vehicle to a service center if the drying procedure does not reduce the humidity level below the threshold humidity level or if the drying procedure does not dry the wet surface.

Aspect 9. The method of any of Aspects 1 to 8, further comprising: sending a message to a passenger device or a device associated with the autonomous vehicle, wherein the message includes an indication of the moisture condition.

Aspect 10. A method performed by an autonomous vehicle, comprising: detecting a moisture condition within the autonomous vehicle based on sensor data received from one or more sensors associated with the autonomous vehicle; in response to detecting the moisture condition, determining, based on the sensor data, that a humidity level within the autonomous vehicle exceeds a threshold humidity level or a wet surface within the autonomous vehicle is present; determining a drying procedure for reducing the humidity level or drying the wet surface within the autonomous vehicle; and configuring one or more components of the autonomous vehicle for implementing the drying procedure.

Aspect 11. The method of Aspect 10, further comprising: receiving the threshold humidity level from an autonomous vehicle fleet management server.

Aspect 12. The method of any Aspects 10-11, wherein the one or more components include at least one of a heating, ventilation, and air conditioning (HVAC) system, a ventilated seat system, and one or more windows.

Aspect 13. The method of any Aspects 10-12, further comprising: determining one or more weather conditions associated with a location of the autonomous vehicle; and modifying the drying procedure based on the one or more weather conditions.

Aspect 14. The method of any Aspects 10-13, wherein the drying procedure includes an estimated time for drying the moisture condition.

Aspect 15. The method of any Aspects 10-14, wherein the sensor data includes at least one of image data, video data, and humidity data.

Aspect 16. The method of any Aspects 10-15, further comprising: sending a message to a passenger device or a device associated with the autonomous vehicle, wherein the message includes an indication of the moisture condition.

Aspect 17. An apparatus comprising: at least one memory comprising instructions; and at least one processor configured to execute the instructions and cause the apparatus to: detect a moisture condition within an autonomous vehicle based on sensor data received from the autonomous vehicle; in response to detecting the moisture condition, determine, based on the sensor data, that a humidity level within the autonomous vehicle exceeds a threshold humidity level or a wet surface within the autonomous vehicle is present; determine a drying procedure for reducing the humidity level or drying the wet surface within the autonomous vehicle; and send a drying instruction for implementing the drying procedure to the autonomous vehicle.

Aspect 18. The apparatus of Aspect 17, wherein the at least one processor is further configured to cause the apparatus to: determine the threshold humidity level based on a plurality of humidity measurements received from a plurality of autonomous vehicles, wherein the plurality of autonomous vehicles is located within a same geographic region as the autonomous vehicle.

Aspect 19. The apparatus of any Aspects 17-18, wherein the drying instruction for implementing the drying procedure includes at least one of a heating, ventilation, and air conditioning (HVAC) instruction, a ventilated seat instruction, and a window configuration instruction.

Aspect 20. The apparatus of any Aspects 17-19, wherein the at least one processor is further configured to cause the apparatus to: determine one or more weather conditions associated with a location of the autonomous vehicle; and modify the drying procedure based on the one or more weather conditions.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method performed by an autonomous vehicle fleet management device, comprising:
detecting a moisture condition within an autonomous vehicle based on sensor data received from the autonomous vehicle;
in response to detecting the moisture condition, determining, based on the sensor data, that a humidity level within the autonomous vehicle exceeds a threshold humidity level or a wet surface within the autonomous vehicle is present;
determining a drying procedure for reducing the humidity level or drying the wet surface within the autonomous vehicle; and
sending a drying instruction for implementing the drying procedure to the autonomous vehicle.

2. The method of claim 1, further comprising:
determining the threshold humidity level based on a plurality of humidity measurements received from a plurality of autonomous vehicles, wherein the plurality of autonomous vehicles is located within a same geographic region as the autonomous vehicle.

3. The method of claim 1, wherein the drying instruction for implementing the drying procedure includes at least one of a heating, ventilation, and air conditioning (HVAC) instruction, a ventilated seat instruction, and a window configuration instruction.

4. The method of claim 1, further comprising:
determining one or more weather conditions associated with a location of the autonomous vehicle; and
modifying the drying procedure based on the one or more weather conditions.

5. The method of claim 1, wherein the drying procedure includes an estimated time for drying the moisture condition.

6. The method of claim 5, further comprising a driving instruction that is based on the estimated time for drying the moisture condition.

7. The method of claim 1, wherein the sensor data includes at least one of image data, video data, and humidity data.

8. The method of claim 1, further comprising a driving instruction to route the autonomous vehicle to a service center if the drying procedure does not reduce the humidity level below the threshold humidity level or if the drying procedure does not dry the wet surface.

9. The method of claim 1, further comprising:
sending a message to a passenger device or a device associated with the autonomous vehicle, wherein the message includes an indication of the moisture condition.

10. A method performed by an autonomous vehicle, comprising:
detecting a moisture condition within the autonomous vehicle based on sensor data received from one or more sensors associated with the autonomous vehicle;
in response to detecting the moisture condition, determining, based on the sensor data, that a humidity level within the autonomous vehicle exceeds a threshold humidity level or a wet surface within the autonomous vehicle is present;
determining a drying procedure for reducing the humidity level or drying the wet surface within the autonomous vehicle; and
configuring one or more components of the autonomous vehicle for implementing the drying procedure.

11. The method of claim 10, further comprising:
receiving the threshold humidity level from an autonomous vehicle fleet management server.

12. The method of claim 10, wherein the one or more components include at least one of a heating, ventilation, and air conditioning (HVAC) system, a ventilated seat system, and one or more windows.

13. The method of claim 10, further comprising:
determining one or more weather conditions associated with a location of the autonomous vehicle; and
modifying the drying procedure based on the one or more weather conditions.

14. The method of claim 10, wherein the drying procedure includes an estimated time for drying the moisture condition.

15. The method of claim 10, wherein the sensor data includes at least one of image data, video data, and humidity data.

16. The method of claim 10, further comprising:
sending a message to a passenger device or a device associated with the autonomous vehicle, wherein the message includes an indication of the moisture condition.

17. An apparatus comprising:
at least one memory comprising instructions; and
at least one processor configured to execute the instructions and cause the apparatus to:
detect a moisture condition within an autonomous vehicle based on sensor data received from the autonomous vehicle;
in response to detecting the moisture condition, determine, based on the sensor data, that a humidity level within the autonomous vehicle exceeds a threshold humidity level or a wet surface within the autonomous vehicle is present;
determine a drying procedure for reducing the humidity level or drying the wet surface within the autonomous vehicle; and
send a drying instruction for implementing the drying procedure to the autonomous vehicle.

18. The apparatus of claim 17, wherein the at least one processor is further configured to cause the apparatus to:
determine the threshold humidity level based on a plurality of humidity measurements received from a plurality of autonomous vehicles, wherein the plurality of autonomous vehicles is located within a same geographic region as the autonomous vehicle.

19. The apparatus of claim 17, wherein the drying instruction for implementing the drying procedure includes at least one of a heating, ventilation, and air conditioning (HVAC) instruction, a ventilated seat instruction, and a window configuration instruction.

20. The apparatus of claim 17, wherein the at least one processor is further configured to cause the apparatus to:
determine one or more weather conditions associated with a location of the autonomous vehicle; and
modify the drying procedure based on the one or more weather conditions.
